(19) United States
(12) Patent Application Publication
(10) Pub. No.: US 2025/0048212 A1
(43) Pub. Date: Feb. 6, 2025

(54) SLICE-SPECIFIC CELL RESELECTION METHOD

(71) Applicant: KYOCERA Corporation, Kyoto-shi (JP)

(72) Inventors: Mitsutaka HATA, Yokohama-shi (JP); Masato FUJISHIRO, Yokohama-shi (JP)

(73) Assignee: KYOCERA Corporation, Kyoto-shi (JP)

(21) Appl. No.: 18/920,204

(22) Filed: Oct. 18, 2024

Related U.S. Application Data
(63) Continuation of application No. PCT/JP2023/015301, filed on Apr. 17, 2023.

(30) Foreign Application Priority Data
Apr. 20, 2022 (JP) 2022-069720

(51) Int. Cl. H04W 36/08; H04W 36/00; H04W 48/18

(52) U.S. Cl. CPC H04W 36/08; H04W 36/0058; H04W 48/18

(57) ABSTRACT

A slice-specific cell reselection method according to one aspect is a slice-specific cell reselection method for a mobile communication system. The slice-specific cell reselection method includes a step of receiving, at a user equipment, a slice priority indicating a priority per network slice from a base station or an access management apparatus. The slice-specific cell reselection method further includes a step of transmitting, at the base station, a slice priority disregard permission message indicating that disregarding a slice priority is permitted when an available capacity of a radio resource is greater than or equal to a threshold value. The slice-specific cell reselection method further includes a step of performing slice-specific cell reselection using the network slice desired by the user equipment without using a slice priority in response to reception of the slice priority disregard permission message.

### RELATED APPLICATIONS

The present application is a continuation based on PCT Application No. PCT/JP2023/015301, filed on Apr. 17, 2023, which claims the benefit of Japanese Patent Application No. 2022-069720 filed on Apr. 20, 2022. The content of which is incorporated by reference herein in their entirety.

### TECHNICAL FIELD

The present disclosure relates to a slice-specific cell reselection method for a mobile communication system.

### BACKGROUND

Specifications of the Third Generation Partnership Project (3GPP) (trade name; the same applies hereinbelow), which is a standardization project for mobile communication systems, define network slicing. Network slicing is a technique for configuring network slices that are virtual networks by logically dividing a physical network constructed by a telecommunications carrier.

A user equipment in a radio resource control (RRC) idle state or an RRC inactive state can perform a cell reselection procedure. The 3GPP has studied slice-specific cell reselection that is a network slice-dependent cell reselection procedure (for example, see Non-Patent Document 1). By performing the slice-specific cell reselection procedure, the user equipment can camp on, for example, a neighboring cell supporting a desired network slice.

In the slice-specific cell reselection procedure, a slice priority which represents a priority per network slice is used. The user equipment performs the slice-specific cell reselection procedure in order from the network slice with the highest slice priority. The 3GPP has discussed provision of slice priority from a network to a user equipment (for example, see Non-Patent Document 2).

### CITATION LIST

### Non-Patent Literature

Non-Patent Document 1: 3GPP TS 38.300 V16.8.0 (2021-12)
Non-Patent Document 2: “RP-220386”, “On RAN Slicing”, Ericsson, Deutsche Telekom, 3GPP TSG-RAN #95-e, 2022-3-17-2022-03-23

### SUMMARY

A slice-specific cell reselection method according to one aspect is a slice-specific cell reselection method for a mobile communication system. The slice-specific cell reselection method includes a step of receiving, at a user equipment, a slice priority indicating a priority per network slice from a base station or an access management apparatus. The slice-specific cell reselection method further includes a step of transmitting, at the base station, a slice priority disregard permission message indicating that disregarding a slice priority is permitted when an available capacity of a radio resource is greater than or equal to a threshold value. The slice-specific cell reselection method further includes a step of performing slice-specific cell reselection using the network slice desired by the user equipment without using a slice priority in response to reception of the slice priority disregard permission message.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a gNB (base station) according to the first embodiment.

FIG. 4 is a diagram illustrating a configuration example of a protocol stack for a user plane according to the first embodiment.

FIG. 5 is a diagram illustrating a configuration example of a protocol stack for a control plane according to the first embodiment.

FIG. 6 is a diagram for describing an overview of a cell reselection procedure.

FIG. 7 is a flowchart indicating a schematic flow of a typical cell reselection procedure.

FIG. 8 is a diagram illustrating an example of network slicing.

FIG. 9 is a diagram illustrating an overview of a slice-specific cell reselection procedure.

FIG. 10 is a diagram indicating an example of slice frequency information.

FIG. 11 is a flowchart indicating a basic flow of the slice-specific cell reselection procedure.

FIG. 12 is a diagram indicating an operation example according to the first embodiment.

FIG. 13 is a diagram indicating an operation example according to a second embodiment.

### DESCRIPTION OF EMBODIMENTS

An aspect of the present disclosure aims to provide a slice-specific cell reselection method that enables user equipment to reselect a cell supporting a network slice desired by the user equipment.

A mobile communication system according to an embodiment is described with reference to the drawings. In the description of the drawings, the same or similar parts are denoted by the same or similar reference signs.

### First Embodiment

### Configuration of Mobile Communication System

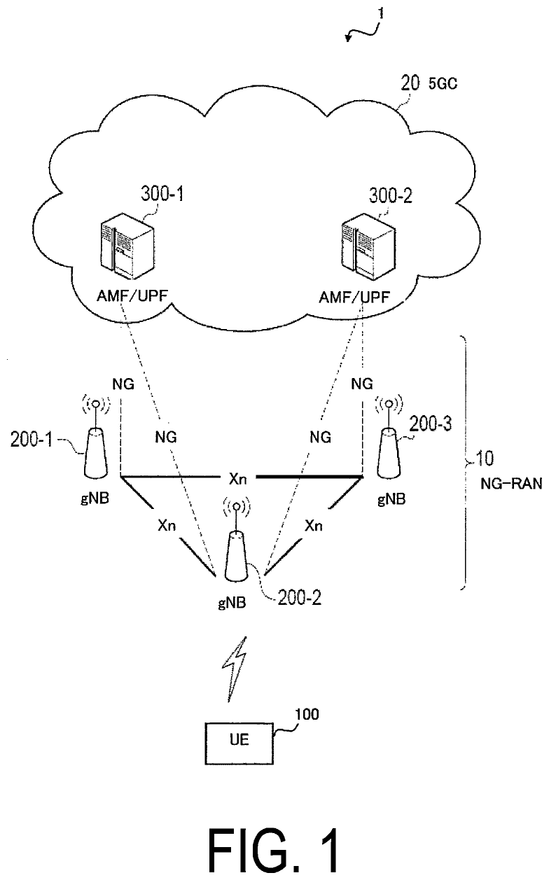

FIG. 1 is a diagram illustrating a configuration of a mobile communication system according to a first embodiment. The mobile communication system 1 complies with the 5th Generation System (5GS) of the 3GPP standard. Although the description below takes the 5GS as an example, a Long Term Evolution (LTE) system may be at least partially applied to the mobile communication system. Alternatively, a sixth-generation (6G) system may be at least partially applied to the mobile communication system.

The mobile communication system 1 includes a user equipment (UE) 100, a 5G radio access network (next generation radio access network (NG-RAN)) 10, and a 5G core network (5GC) 20. The NG-RAN 10 may be hereinafter simply referred to as a RAN 10. In addition, the 5GC 20 may be simply referred to as a core network (CN) 20.

The UE 100 is a mobile wireless communication apparatus. The UE 100 may be any apparatus as long as a user uses the UE 100. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (vehicle UE), and a flying object or an apparatus provided on a flying object (aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. A “cell” is used as a term representing a minimum unit of a wireless communication area. A “cell” is also used as a term representing a function or a resource for performing wireless communication with the UE 100. One cell belongs to one carrier frequency (hereinafter simply referred to as one “frequency”).

Further, the gNB can be connected to an evolved packet core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility control and the like for the UE 100. The AMF manages mobility of the UE 100 by communicating with the UE 100 by using Non-Access Stratum (NAS) signaling. The UPF controls data transfer. The AMF and UPF are connected to the gNBs 200 via an NG interface which is an interface between a base station and the core network.

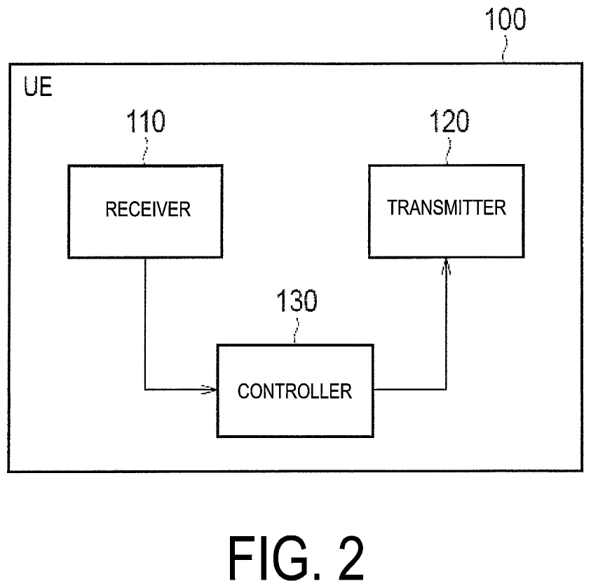

FIG. 2 is a diagram illustrating a configuration of the user equipment (UE) 100 according to the first embodiment. The UE 100 includes a receiver 110, a transmitter 120, and a controller 130. The receiver 110 and the transmitter 120 constitute a wireless communicator that performs wireless communication with the gNBs 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processing in the UE 100. Such processing includes processing of respective layers to be described below. The controller 130 includes at least one processor and at least one memory. The memory stores a program to be executed by the processor and information to be used for processing by the processor. The processor may include a baseband processor and a central processing unit (CPU). The baseband processor performs modulation and demodulation, coding and decoding, and the like of baseband signals. The CPU executes the program stored in the memory to thereby perform various types of processing. Further, the controller 130 may perform all types of processing and operations in the UE 100 in each embodiment to be described below.

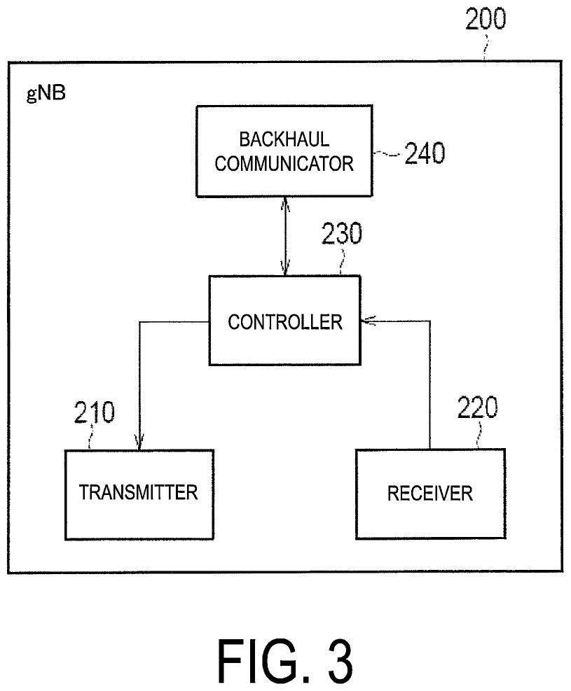

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processing in the gNB 200. Such processing includes processing of respective layers to be described below. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of baseband signals. The CPU executes the program stored in the memory to thereby perform various types of processing. Further, the controller 230 may perform all types of processing and operations in the gNB 200 in each embodiment to be described below.

The backhaul communicator 240 is connected to a neighboring base station via an Xn interface which is an inter-base station interface. The backhaul communicator 240 is connected to the AMF/UPF 300 via an NG interface between a base station and the core network. Further, the gNB 200 may include a Central Unit (CU) and a Distributed Unit (DU) (i.e., divided functions), and the two units may be connected via an F1 interface, which is a fronthaul interface.

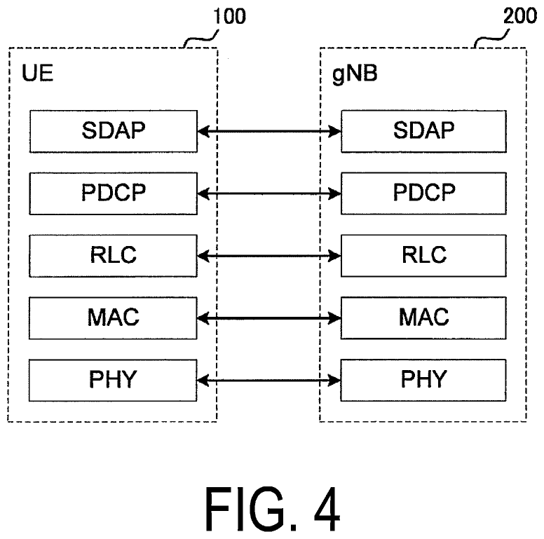

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Further, the PHY layer of the UE 100 receives downlink control information (DCI) transmitted from the gNB 200 over a physical downlink control channel (PDCCH). Specifically, the UE 100 performs blind decoding on the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through a Hybrid Automatic Repeat reQuest (hybrid ARQ or HARQ), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) of the uplink and the downlink, and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by the core network and a radio bearer as the unit of QoS control performed by an Access Stratum (AS). Further, when the RAN is connected to the EPC, the SDAP need not be provided.

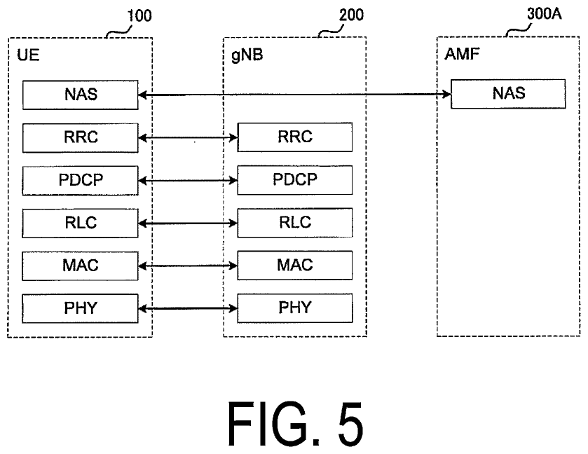

FIG. 5 is a diagram illustrating a configuration of a protocol stack of a radio interface of a control plane handling signaling (control signal).

The protocol stack of the radio interface of the control plane includes a Radio Resource Control (RRC) layer and a Non-Access Stratum (NAS), instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection between the RRC of the UE 100 and the RRC of the gNB 200 (RRC connection) is present, the UE 100 is in an RRC connected state. When any connection between the RRC of the UE 100 and the RRC of the gNB 200 (RRC connection) is not present, the UE 100 is in an RRC idle state. When a connection between the RRC of the UE 100 and the RRC of the gNB 200 is suspended, the UE 100 is in an RRC inactive state.

The NAS which is positioned above the RRC layer performs session management, mobility management, and the like. NAS signaling is transmitted between the NAS of the UE 100 and the NAS of the AMF 300. Further, the UE 100 includes an application layer other than the protocol of the radio interface. In addition, a layer lower than the NAS is referred to as Access Stratum (AS).

### Overview of Cell Reselection Procedure

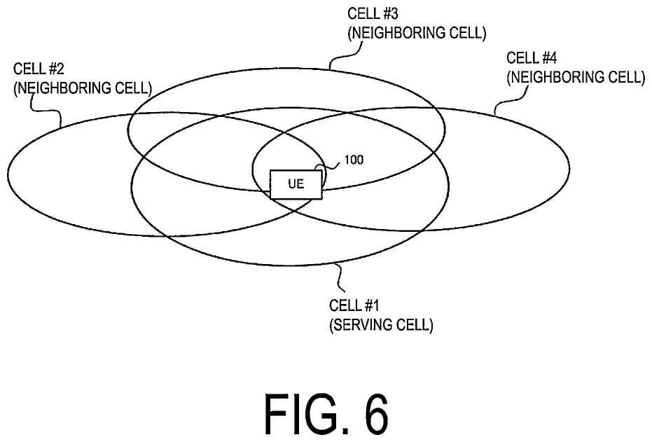

FIG. 6 is a diagram for describing an overview of a cell reselection procedure.

The UE 100 in the RRC idle state or the RRC inactive state performs the cell reselection procedure to transition from a current serving cell (cell #1) to a neighboring cell (any one of cells #2 to #4) according to movement. To be more specific, the UE 100 specifies a neighboring cell to be camped on by the UE 100 through the cell reselection procedure and reselects the specified neighboring cell. A state in which the current serving cell and a neighboring cell have the same frequency (carrier frequency) is referred to as intra-frequency, and a state in which the current serving cell and a neighboring cell have different frequencies (carrier frequencies) is referred to as inter-frequency. The current serving cell and the neighboring cell may be managed by the same gNB 200 or different gNBs 200.

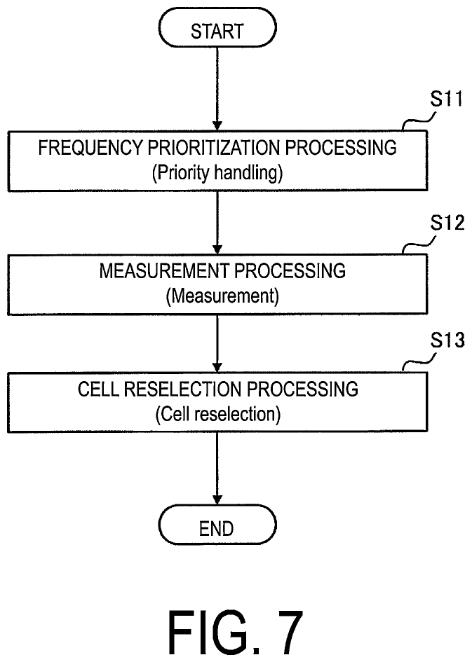

FIG. 7 is a flowchart indicating a schematic flow of a typical (or legacy) cell reselection procedure.

In step S11, the UE 100 performs frequency prioritization processing based on frequency-specific priorities (also referred to as “absolute priorities”) specified by the gNB 200, for example, by means of a system information block or an RRC release message. To be more specific, the UE 100 manages the frequency priority designated by the gNB 200 for each frequency.

In step S12, the UE 100 performs measurement processing of measuring radio qualities of the serving cell and each of the neighboring cells. The UE 100 measures reception powers and reception qualities of reference signals transmitted by the serving cell and each of the neighboring cells, to be more specific, a Cell Defining-Synchronization Signal and PBCH block (CD-SSB). For example, the UE 100 always measures the radio quality for frequencies having a higher priority than the frequency of the current serving cell, and for frequencies having a priority equal to or lower than the priority of the frequency of the current serving cell, measures the radio quality of the frequency having the priority equal to or lower than the priority of the frequency of the current serving cell when the radio quality of the current serving cell is below a predetermined quality.

In step S13, the UE 100 performs cell reselection processing of reselecting a cell on which the UE 100 camps based on the measurement result in step S12. For example, the UE 100 may perform cell reselection to a neighboring cell when the priority of the frequency of the neighboring cell is higher than the priority of the current serving cell and the neighboring cell satisfies a minimum required quality standard (i.e., a minimal quality standard) for a predetermined period of time. When the priorities of the frequencies of the neighboring cells are the same as the priority of the current serving cell, the UE 100 may rank the radio qualities of the neighboring cells to perform cell reselection on the neighboring cell ranked higher than the rank of the current serving cell for a predetermined period of time. When the priorities of the frequencies of the neighboring cells are lower than the priority of the current serving cell, the radio quality of the current serving cell is lower than a certain threshold value, and the radio quality of the neighboring cells is continuously higher than another threshold value for a predetermined period of time, the UE 100 may perform cell reselection on the neighboring cell.

### Overview of Network Slicing

Network slicing is a technique for virtually dividing a physical network (for example, a network including the NG-RAN 10 and the 5GC 20) constructed by a carrier to create a plurality of virtual networks. Each virtual network is referred to as a network slice. Hereinafter, a “network slice” may be simply referred to as a “slice”.

Network slicing allows a telecommunications carrier to create slices according to service requirements of different service types, such as enhanced Mobile Broadband (eMBB), Ultra-Reliable and Low Latency Communications (URLLC), and massive Machine Type Communications (mMTC), for example, to optimize network resources.

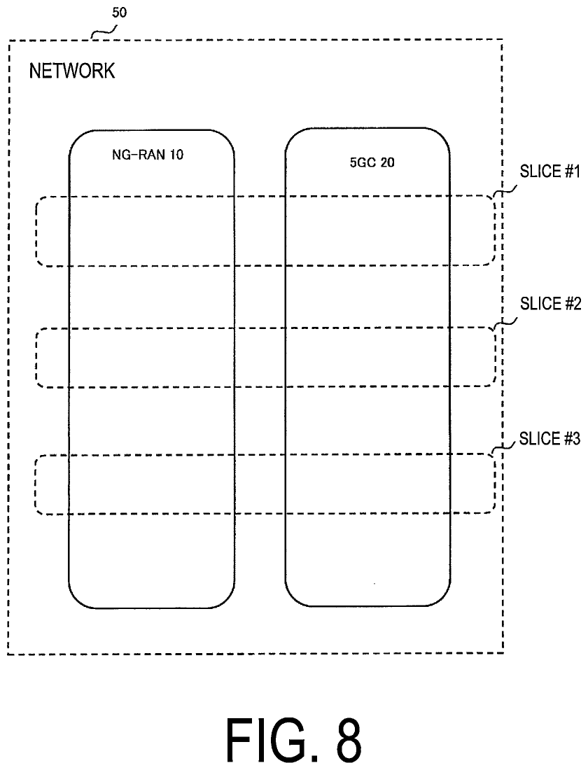

FIG. 8 is a diagram illustrating an example of network slicing.

Three slices (slices #1 to #3) are configured on a network 50 including the NG-RAN 10 and the 5GC 20. The slice #1 is associated with the service type of eMBB, the slice #2 is associated with the service type of URLLC, and the slice #3 is associated with the service type of mMTC. Further, three or more slices may be configured on the network 50. One service type may be associated with a plurality of slices.

Each slice is provided with a slice identifier for identifying the slice. Examples of the slice identifier include Single Network Slicing Selection Assistance Information (S-NSSAI). The S-NSSAI includes an 8-bit slice/service type (SST). The S-NSSAI may further include a 24-bit slice differentiator (SD). The SST is information indicating a service type with which a slice is associated. The SD is information for differentiating a plurality of slices associated with the same service type. The information including a plurality of pieces of S-NSSAI is referred to as Network Slice Selection Assistance Information (NSSAI).

In addition, one or more slices may be grouped to configure a slice group. In addition, the slice group is a group including one or more slices, and a slice group identifier is assigned to the slice group. The slice group may be configured by a core network (for example, the AMF 300), or may be configured by a radio access network (for example, the gNB 200). The UE 100 may be notified of the configured slice group.

Hereinafter, the term “network slice (slice)” may refer to S-NSSAI that is an identifier of a single slice or NSSAI that is a collection of pieces of S-NSSAI. Alternatively, the term “network slice (slice)” may refer to a slice group that is a group of one or more pieces of S-NSSAI or NSSAI.

In addition, the UE 100 determines a desired slice that the UE 100 desires to use. The desired slice may be referred to as an “Intended slice”. In the first embodiment, the UE 100 determines a slice priority for each network slice (desired slice). For example, the NAS of the UE 100 determines the slice priority based on an operation status of an application in the UE 100 and/or a user operation/configuration, and notifies the AS of slice priority information indicating the determined slice priority.

### Overview of Slice-Specific Cell Reselection Procedure

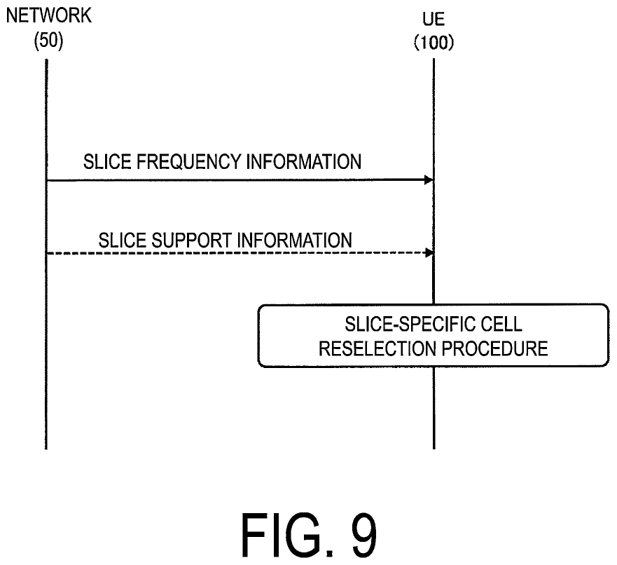

FIG. 9 is a diagram illustrating an overview of a slice-specific cell reselection (slice-specific cell reselection, slice aware cell reselection, or slice based cell reselection) procedure.

In the slice-specific cell reselection procedure, the UE 100 performs cell reselection processing based on slice frequency information provided from the network 50. The slice frequency information may be provided from the gNB 200 to the UE 100 through broadcast signaling (for example, a system information block) or dedicated signaling (for example, an RRC release message).

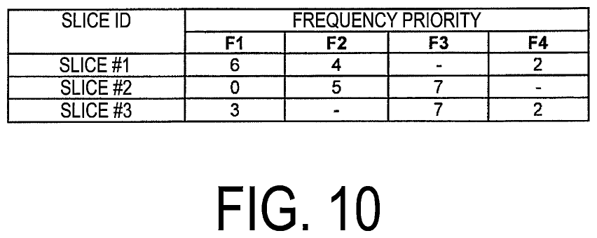

The slice frequency information is information indicating a correspondence relationship between network slices, frequencies, and frequency priorities. For example, the slice frequency information indicates, for each slice (or slice group), a frequency (one or more frequencies) that supports the slice and a frequency priority assigned to each frequency. FIG. 10 indicates an example of the slice frequency information.

In the example indicated in FIG. 10, three frequencies F1, F2, and F4 are associated with slice #1 as frequencies that support the slice #1. Among these three frequencies, the frequency priority of F1 is “6”, the frequency priority of F2 is “4”, and the frequency priority of F4 is “2”. In the example of FIG. 10, although the larger the number of the frequency priority, the higher the priority is, the priority may be higher as the number is smaller.

In addition, three frequencies F1, F2, and F3 are associated with slice #2 as frequencies that support the slice #2. Among these three frequencies, the frequency priority of F1 is “0”, the frequency priority of F2 is “5”, and the frequency priority of F3 is “7”.

In addition, three frequencies F1, F3, and F4 are associated with slice #3 as frequencies that support the slice #3. Among these three frequencies, the frequency priority of F1 is “3”, the frequency priority of F3 is “7”, and the frequency priority of F4 is “2”.

Hereinafter, the frequency priority indicated in the slice frequency information may be referred to as a “slice-specific frequency priority” in order to be distinguished from the absolute priority in the cell reselection procedure of the related art.

As illustrated in FIG. 9, the UE 100 may perform the cell reselection processing based on slice support information provided from the network 50. The slice support information may be information indicating a correspondence relationship between a cell (for example, a serving cell and each neighboring cell) and a network slice that is not provided or is provided by the cell. For example, a certain cell may temporarily fail to provide some or all network slices due to congestion or the like. That is, even for a slice support frequency capable of providing a certain network slice, some cells within the frequency may not provide the network slice. Based on the slice support information, the UE 100 may recognize which network slice is not provided by each cell. Such slice support information may be provided from the gNB 200 to the UE 100 through broadcast signaling (for example, a system information block) or dedicated signaling (for example, an RRC release message).

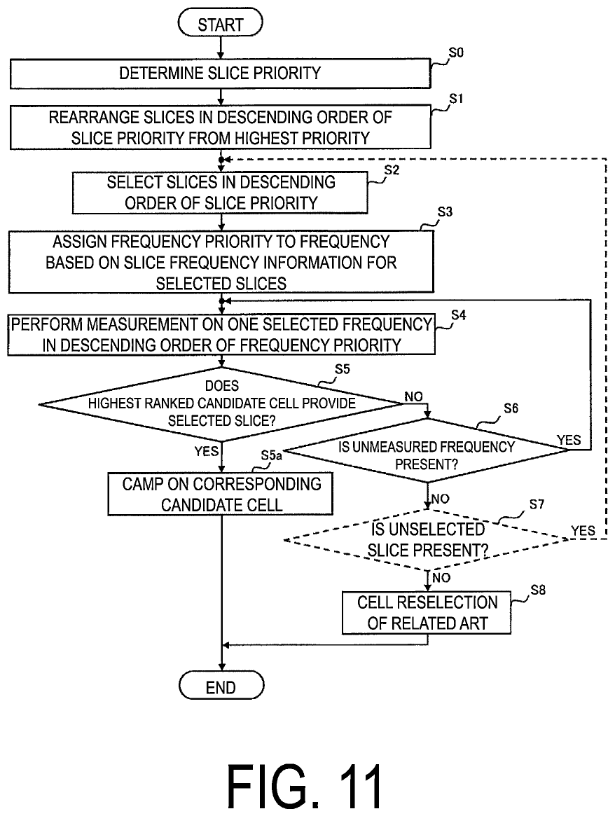

FIG. 11 is a flowchart indicating a basic flow of the slice-specific cell reselection procedure. Before starting the slice-specific cell reselection procedure, the UE 100 is assumed to be in the RRC idle state or the RRC inactive state, and to receive and retain the above-mentioned slice frequency information. Further, the procedure of “slice-specific cell reselection” indicates a “slice-specific cell reselection procedure”. However, in the following, “slice-specific cell reselection” and the “slice-specific cell reselection procedure” may be used in the same sense.

In step S0, the NAS of the UE 100 determines the slice identifiers of desired slices for the UE 100 and the slice priorities of the desired slices, and notifies the AS of the UE 100 of slice priority information including the determined slice priorities. A “desired slice” is an “Intended slice”, and includes a slice that is likely to be used, a candidate slice, a wanted slice, a slice in which communication is desired, a requested slice, an allowed slice, or an intended slice. For example, the slice priority of the slice #1 is determined to be “3”, the slice priority of the slice #2 is determined to be “2”, and the slice priority of the slice #3 is determined to be “1”. Although the larger the number of the slice priority, the higher the priority is, the priority may be higher as the number is smaller.

In step S1, the AS of the UE 100 rearranges the slices (slice identifiers), of which the AS is notified by the NAS in step S0, in descending order of slice priority. A list of the slices arranged in this manner is referred to as a “slice list”.

In step S2, the AS of the UE 100 selects one network slice in descending order of slice priority. The network slice selected in this manner is referred to as a “selected network slice”.

In step S3, the AS of the UE 100 assigns, for the selected network slice, a frequency priority to each of the frequencies associated with that network slice. To be more specific, the AS of the UE 100 specifies frequencies associated with the slice based on the slice frequency information and assigns frequency priorities to the specified frequencies. For example, when the selected network slice selected in step S2 is the slice #1, the AS of the UE 100 assigns the frequency priority “6” to the frequency F1, the frequency priority “4” to the frequency F2, and the frequency priority “2” to the frequency F4 based on the slice frequency information (for example, the information in FIG. 10). The AS of the UE 100 refers to a list of frequencies arranged in descending order of frequency priority as a “frequency list”.

In step S4, the AS of the UE 100 selects one of the frequencies in descending order of frequency priority for the selected network slice selected in step S2, and performs measurement processing on the selected frequency. The frequency selected in this manner is referred to as a “selected frequency”. The AS of the UE 100 may rank the cells measured within the selected frequency in descending order of radio quality. Among the cells measured within the selected frequency, cells that satisfy a predetermined quality standard (i.e., a minimum required quality standard) are referred to as “candidate cells”.

In step S5, the AS of the UE 100 specifies the cell at the highest rank based on the result of the measurement processing in step S4, and determines whether the cell provides the selected network slice based on the slice support information. When it is determined that the cell at the highest rank provides the selected network slice (step S5: YES), the AS of the UE 100 reselects the cell at the highest rank and camps on the cell in step S5a.

On the other hand, when it is determined that the cell at the highest rank cell does not provide the selected network slice (step S5: NO), the AS of the UE 100 determines in step S6 whether a frequency not measured is present in the frequency list created in step S3. In other words, the AS of the UE 100 determines whether a frequency assigned in step S3 other than the selected frequency is present in the selected network slice. When it is determined that a frequency not measured is present (step S6: YES), the AS of the UE 100 resumes the processing for the frequency having the next highest frequency priority, and performs the measurement processing by use of that frequency as selected frequency (returns the processing to step S4).

When it is determined that a frequency not measured is not present in the frequency list created in step S3 (step S6: NO), the AS of the UE 100 may determine in step S7 whether an unselected slice is present in the slice list created in step S1. In other words, the AS of the UE 100 may determine whether a network slice other than the selected network slice is present in the slice list. When it is determined that an unselected slice is present (step S7: YES), the AS of the UE 100 resumes the processing for the network slice having the next highest slice priority, and selects that network slice as the selected network slice (returns the processing to step S2). Further, in the basic flow indicated in FIG. 11, the processing of step S7 may be omitted.

When it is determined that an unselected slice is not present (step S7: NO), the AS of the UE 100 performs the cell reselection processing of the related art in step S8. The cell reselection processing of the related art may mean the entirety of the typical (or legacy) cell reselection procedure indicated in FIG. 7. Alternatively, the cell reselection processing of the related art may also mean only cell reselection processing (step S30) indicated in FIG. 7. In the latter case, the UE 100 may use the measurement result of step S4 without measuring the radio qualities of the cells again.

Further, the typical cell reselection procedure indicated in FIG. 7 may be referred to as a “legacy cell reselection procedure”. In addition, although a procedure of “legacy cell reselection” indicates a “legacy cell reselection procedure”, the “legacy cell reselection” and the “legacy cell reselection procedure” may be used without being distinguished from each other in the following description.

### Slice-Specific Cell Reselection Method According to First Embodiment

As described above, in the slice-specific cell reselection procedure, processing is performed in order from the network slice having the highest slice priority. The AS of the UE 100 is notified of the slice priority by the NAS of the UE 100, and the AS of the UE 100 performs the slice-specific cell reselection procedure using the slice priorities.

Regarding this slice priority, the 3GPP has discussed provision of slice priorities by the network 50 to the UE 100. Thereby, for example, (part of) the slice-specific cell reselection procedure performed in the UE 100 can be controlled on the network 50 side.

However, with respect to a slice priority provided from the network 50 side, a network slice having a lower slice priority than others may be a network slice desired by the user (or the UE 100). In such a case, even when the slice-specific cell reselection procedure is performed in the UE 100, the cell supporting the desired network slice may not be reselected because the slice priority is lower than others. For this reason, the UE 100 may not be able to execute the application desired by the user.

Thus, it is an object of the first embodiment to provide a slice-specific cell reselection method that enables the UE 100 to reselect a cell supporting a network slice desired by the UE.

Thus, in the first embodiment, when a predetermined condition is satisfied, the gNB 200 transmits a slice priority disregard permission message indicating that disregarding the slice priority transmitted from the network 50 is permitted. In addition, in response to the reception of the message, the UE 100 performs slice-specific cell reselection using the network slice desired by the UE 100 without using the slice priority received from the network 50.

To be specific, first, user equipment (for example, the UE 100) receives a slice priority indicating the priority per network slice from a base station (for example, the gNB 200) or an access management apparatus (for example, the AMF 300). Second, when the available capacity of radio resources is equal to or greater than a threshold value, the base station transmits a slice priority disregard permission message indicating that disregarding the slice priority is permitted. Third, in response to receiving the slice priority disregard permission message, the user equipment performs slice-specific cell reselection using the network slice desired by the user equipment without using the slice priority.

As a result, for example, when the UE 100 receives the slice priority disregard permission message, it can execute the slice-specific cell reselection procedure by setting the highest priority to the network slice desired by the UE. Thus, the UE 100 can reselect the cell supporting the network slice desired by the UE 100 itself by executing the procedure.

The predetermined condition is that the available capacity of radio resources used for wireless communication between the gNB 200 and the UE 100 is greater than or equal to a threshold value. The reason for this is as follows, for example.

That is, the 3GPP described that control of slice-specific cell reselection by the network 50 has been discussed. One reason for the network 50 desiring to control slice-specific cell reselection is load distribution for the UE 100. For example, when the UEs 100 perform the slice-specific cell reselection procedure at a time, a specific radio resource may be intensively used between the UEs 100 and the gNB 200. This is the reason for the network 50 controlling slice-specific cell reselection in order to suppress such a situation as much as possible and accomplish load distribution for the UE 100. Therefore, if the available capacity of the radio resource is greater than or equal to the threshold value, the UE 100 can perform slice-specific cell reselection preferentially for the network slice desired by the UE, instead of following control from the network 50 side. Therefore, in the first embodiment, a condition for the radio resources is provided as a predetermined condition.

Further, a frequency priority (that is, a slice-specific frequency priority) can be controlled on the network 50 side. As described above, the frequency priority is included in the slice frequency information, and the network 50 notifies the UE 100 of the frequency priority. Thus, the network 50 can also change the frequency priority.

However, there is a possibility that a change in the frequency priority may affect a large number of the UEs 100, and may also affect a deployment scenario on the network 50 side.

Thus, in the first embodiment, a control target is described as a slice priority, not a frequency priority.

### Operation Example of First Embodiment

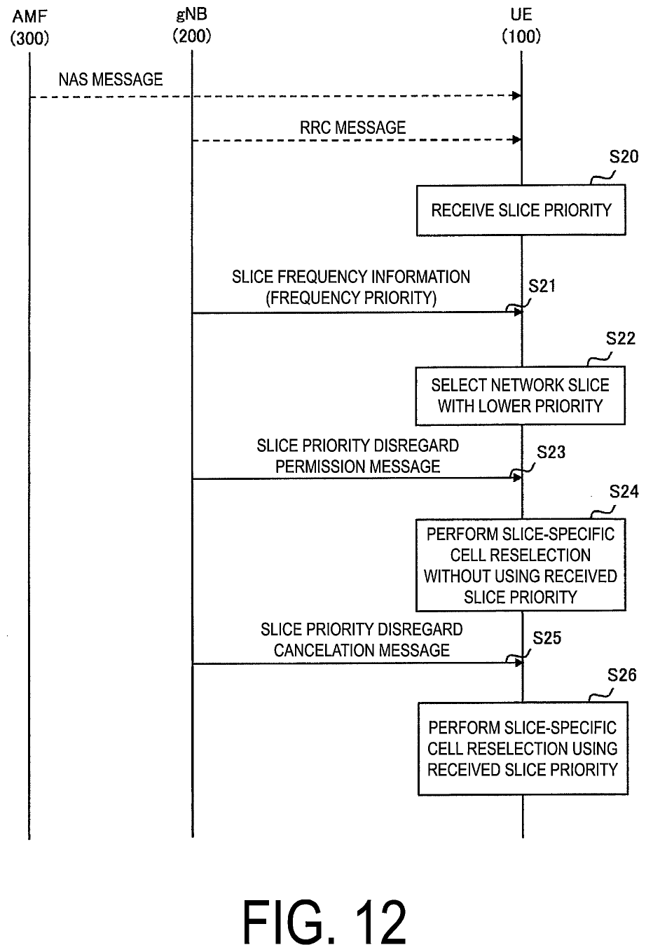

FIG. 12 is a flowchart indicating an operation example according to the first embodiment.

As illustrated in FIG. 12, in step S20, the UE 100 receives the slice priority information including slice priorities. The NAS of the UE 100 may receive a NAS message (for example, a Registration Accept message) including the slice priority information from the AMF 300. The NAS of the UE 100 outputs the received slice priority information to the AS of the UE 100. In addition, the NAS of the UE 100 may also receive slice priority information from a user application. The slice priority information received by the NAS of the UE 100 from the user application may be slice priority information about network slices allowed in Allowed NSSAI received from the AMF 300. In addition, the slice priority information received by the NAS of the UE 100 from the user application may be slice priority information designated by the user application, regardless of the information received from the network side such as the AMF 300. Also in this case, the NAS of the UE 100 outputs the received slice priority information to the AS of the UE 100. Further, the AS of the UE 100 may receive an RRC message including the slice priority information from the gNB 200. The RRC message may be a system information block (SIB) or an RRC release (RRCRelease) message.

In step S21, the gNB 200 transmits the slice frequency information including frequency priorities. As described above, the gNB 200 may transmit the slice frequency information by using the RRC message including the slice frequency information.

In step S22, the application of the UE 100 selects a network slice with a lower priority than others as a desired network slice. Then, the application of the UE 100 outputs information about the network slice to the AS of the UE 100 via the NAS of the UE 100.

Here, it is assumed that, in step S20, the AS of the UE 100 has received slice priority information indicating that the slice priority of network slice #1 is “7” and the slice priority of network slice #2 is “1” (the larger the value of the slice priority, the higher the slice priority). In addition, it is assumed in step S22 that the application of the UE 100 has selected the network slice #2 as a desired network slice. If the AS of the UE 100 still performs slice-specific cell reselection according to the slice priority received from the network 50, the AS of the UE 100 may reselect a cell supporting the network slice #1 and may not reselect a cell supporting the network slice #2 desired by the application of the UE 100.

In step S23, when the available capacity of the radio resource is greater than or equal to a threshold value, the gNB 200 transmits a message indicating that disregarding the slice priority transmitted from the network 50 is permitted. Such a message is referred to as a slice priority disregard permission message. The gNB 200 may transmit a slice priority disregard permission message through an RRC message such as broadcast signaling (for example, an SIB) or dedicated signaling (for example, an RRC Release message).

In step S24, in response to the reception of the slice priority disregard permission message, the UE 100 performs slice-specific cell reselection using the network slice (step S22) desired by the UE 100 without using the slice priority (step S20) received from the network 50 side. In the above example, the AS of the UE 100 performs slice-specific cell reselection using the network slice #2 desired by the application of the UE 100 without using the network slice #1 with the highest slice priority.

In step S25, the gNB 200 transmits a message indicating cancellation of the permission to disregard the slice priority transmitted from the network 50 when the available capacity of the radio resource is less than the threshold value. Such a message is referred to as a slice priority disregard cancellation message. The gNB 200 may transmit a slice priority disregard cancellation message through an RRC message such as broadcast signaling (for example, an SIB) or dedicated signaling (for example, an RRC Release message).

In step S26, in response to the reception of the slice priority disregard cancellation message, the UE 100 performs slice-specific cell reselection using the slice priority (step S20) received from the network 50.

As described above, in the first embodiment, the UE 100 performs slice-specific cell reselection using the network slice desired by the UE 100 itself until the slice priority disregard cancellation message is received after the slice priority disregard permission message is received. Thus, the UE 100 can reselect a cell supporting the network slice desired by the UE itself, and can also execute a user application desired by the UE itself, for example.

Although the example in which the slice priority disregard permission message (step S23) and the slice priority disregard cancellation message (step S25) are transmitted from the gNB 200 has been described in the first embodiment, the present invention is not limited thereto. The slice priority disregard permission message and the slice priority disregard cancellation message may be transmitted from the AMF 300 to the UE 100. In this case, the slice priority disregard permission message and the slice priority disregard cancellation message are transmitted by using a NAS message. For example, when the available capacity of the radio resource is greater than or equal to the threshold value, the gNB 200 may transmit a message indicating that intent (or a message indicating that the slice priority disregard permission message may be transmitted) to the AMF 300, and the AMF 300 may transmit the slice priority disregard permission message to the UE 100 in response to reception of the message. In addition, for example, when the available capacity of the radio resource is less than the threshold value, the gNB 200 may transmit a message indicating that intent (or a message indicating that the slice priority disregard cancellation message may be transmitted) to the AMF 300, and the AMF 300 may transmit the slice priority disregard cancellation message in response to reception of the message.

### First Variation of First Embodiment

Next, a first variation of the first embodiment will be described.

Although an example in which the UE 100 performs slice-specific cell reselection using the network slice desired by the UE in response to reception of the slice priority disregard permission message has been described in the first embodiment, the present invention is not limited thereto. For example, when the UE 100 does not receive a slice priority (step S20) from the gNB 200 or the AMF 300, the UE 100 may perform slice-specific cell reselection using the network slice desired by the UE 100. That is, when the UE 100 does not receive the slice priority from the network 50, the UE 100 performs slice-specific cell reselection using the network slice as desired by the UE 100. If the network 50 transmits no slice priority, the network 50 may give signaling to the UE 100 indicating that 1) the UE 100 may disregard the slice priority, or 2) it may follow existing cell reselection. For example, the gNB 200 may transmit an RRC message including information indicating the indication to the UE 100. Alternatively, for example, the AMF 300 may transmit a NAS message including information indicating the indication to the UE 100.

However, when receiving the frequency priority (step S21), the UE 100 performs slice-specific cell reselection according to the frequency priority. The slice frequency information indicates a relationship between a network slice, the frequency supported by the network slice, and the frequency priority of the frequency. Thus, the UE 100 performs slice-specific cell reselection according to frequency priorities, for example, sequentially from the network slice supporting the frequency with the highest priority.

Further, in consideration of load distribution of the UE 100, the gNB 200 may not transmit the slice priority when the available capacity of the radio resource is greater than or equal to the threshold value, and may transmit the slice priority when the available capacity of the radio resource is less than the threshold value. The UE 100 performs slice-specific cell reselection using the network slice desired by the UE itself when the slice priority has not been received, and the UE performs slice-specific cell reselection using the slice priority when the slice priority has been received.

### Second Variation of First Embodiment

Next, a second variation of the first embodiment will be described.

Although the gNB 200 that transmits a slice priority disregard permission message indicating that disregarding the slice priority is permitted has been described in the first embodiment, the invention is not limited thereto. For example, the gNB 200 may transmit a message indicating that the network slice desired by the UE 100 (or the slice priority desired by the UE 100) is applied when the available capacity of the radio resource is greater than or equal to the threshold value. Alternatively, the gNB 200 may transmit a message indicating that the desire (or preference) of the UE 100 for network slices (or slice priorities) is followed when the available capacity of the radio resource is greater than or equal to the threshold value. In response to reception of these messages, the UE 100 performs slice-specific cell reselection using the network slice desired by the UE itself (or the slice priority desired by the UE itself) same as and/or similarly to in the first embodiment. Then, the gNB 200 may transmit a message indicating cancellation of the application of the network slice desired by the UE 100 (or the slice priority desired by the UE 100) when the available capacity of the radio resource is less than the threshold value. Alternatively, the gNB 200 may transmit a message indicating that following the desire (or preference) of the UE 100 for network slices (or slice priorities) is canceled when the available capacity of the radio resource is less than the threshold value. In response to reception of these messages, the UE 100 performs slice-specific cell reselection using the slice priority received from the network 50.

### Third Variation of First Embodiment

Next, a third variation of the first embodiment will be described.

Although an example in which the UE 100 selects one network slice having a lower priority than others has been described in the first embodiment, the present invention is not limited thereto. For example, the UE 100 may select multiple network slices with lower priorities than others. In this case, the UE 100 may configure slice priorities for the multiple selected network slices. In response to the reception of the slice priority disregard permission message (step S23), the UE 100 performs slice-specific cell reselection using the slice priority configured by the UE itself. In addition, in response to the reception of the slice priority disregard cancellation message (step S25), the UE 100 performs slice-specific cell reselection using the slice priority received from the network 50.

Further, the UE 100 may configure the slice priority in the NAS of the UE 100 or the application of the UE 100. For example, multiple network slices may be selected in the application of the UE 100, and slice priorities may be configured for the multiple network slices in the NAS of the UE 100.

### Second Embodiment

Next, a second embodiment will be described.

In the current specifications of the 3GPP, the UE 100 has no mechanism to transmit the slice priority desired by the UE itself to the network 50. In addition, the UE 100 has no mechanism to transmit a changed slice priority to the network 50 even when the slice priority desired by the UE itself is changed. Thus, according to the current specifications, slice-specific cell reselection that meets the desire of the UE 100 may not be able to be performed. Therefore, the same as and/or similarly to in the first embodiment, the UE 100 may not be able to reselect a cell supporting the network slice desired by itself.

Therefore, in the second embodiment, if the slice priority transmitted by the network 50 is different from the slice priority desired by the UE 100, the gNB 200 or the AMF 300 transmits the slice priority desired by the UE 100 when the available capacity of the radio resource is greater than or equal to the threshold value.

To be specific, first, a user equipment (for example, the UE 100) transmits a first slice priority that represents the priority per network slice and that is desired by the user equipment to a base station (for example, the gNB 200) or an access management apparatus (or the AMF 300). Second, when a second slice priority transmitted by the base station or the access management apparatus is different from the first slice priority, the base station or the access management apparatus transmits the first slice priority when the available capacity of the radio resource is greater than or equal to the threshold value. Third, in response to reception of the first slice priority, the user equipment performs slice-specific cell reselection using the first slice priority.

Accordingly, for example, since the UE 100 can perform slice-specific cell reselection using the slice priority desired by the UE 100, slice-specific cell reselection that satisfies the desire of the UE 100 can be performed. Thus, the UE 100 itself can also reselect a cell supporting the desired network slice.

### Operation Example of Second Embodiment

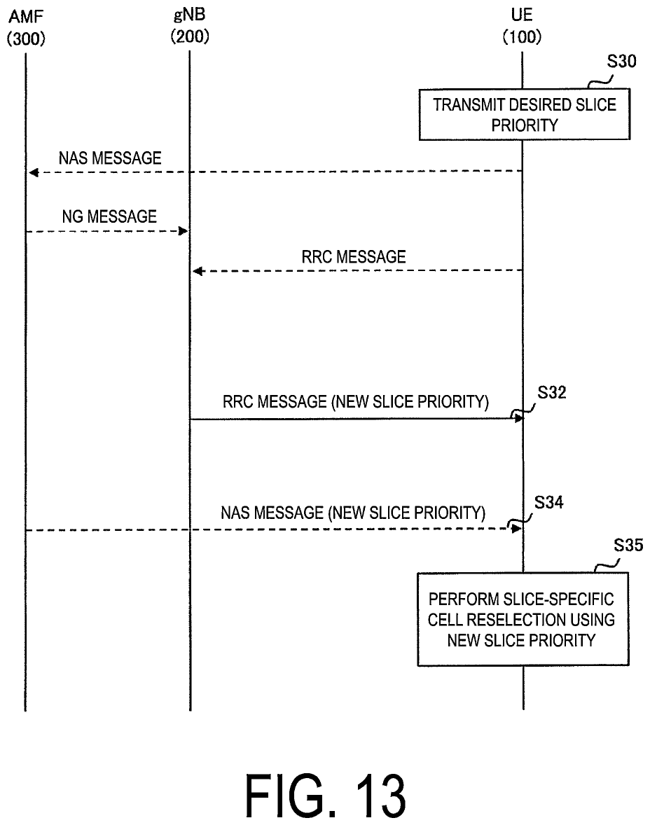

FIG. 13 is a diagram illustrating an operation example according to the second embodiment. Further, before performing the processing illustrated in FIG. 13, the gNB 200 or the AMF 300 is assumed to transmit slice priority information including slice priorities. For example, the gNB 200 may transmit the slice priority information using an RRC message. Alternatively, the AMF 300 may transmit the slice priority information using a NAS message. When the AMF 300 transmits the slice priority information, the gNB 200 is assumed to receive the slice priority information from the AMF 300. In other words, even when the AMF 300 transmits the slice priority information, the gNB 200 is assumed to ascertain the slice priority transmitted by the AMF 300.

As illustrated in FIG. 13, in step S30, the UE 100 determines a slice priority desired by itself (for example, a first slice priority), and transmits slice priority information including the slice priority (for example, first slice priority information) to the network 50.

First, the UE 100 may transmit the slice priority information to the AMF 300. In this case, the NAS of the UE 100 may transmit the slice priority desired by itself to the AMF 300 by transmitting a NAS message (for example, a Registration Request message) including the slice priority information. In this case, the AMF 300 may transmit an NG message including the slice priority information to the gNB 200. The gNB 200 receives the slice priority desired by the UE 100 via the AMF 300. After transmitting the slice priority information to the AMF 300, the NAS of the UE 100 may output the slice priority desired by itself to the AS of the UE 100.

Second, the UE 100 may transmit the slice priority information to the gNB 200. In this case, the NAS of the UE 100 outputs the slice priority desired by itself to the AS of the UE 100. Then, the AS of the UE 100 transmits the slice priority information including the slice priority to the gNB 200. The AS of the UE 100 may transmit the slice priority information by transmitting an RRC message (for example, an RRC setup request (RRCSetupRequest) message) including the slice priority information to the gNB 200. In this case, the gNB 200 receives the slice priority desired by the UE 100 directly from the UE 100.

In the slice priority information, multiple network slices (desired by the UE 100) may be in the form of a list, and the order of entries in the list may indicate the slice priority. For example, the first entry in the list represents the network slice of the highest priority and the next entry represents the network slice of the second highest priority. In addition, for example, the entry order of each piece of S-NSSAI included in Configured NSSAI (or the Allowed NSSAI or the Requested NSSAI) may indicate the slice priority. Because a maximum of eight pieces of S-NSSAI are included in the Configured NSSAI, for example, when eight pieces of S-NSSAI are included, the first entry in the Configured NSSAI represents the network slice of the highest priority, the next entry represents the network slice of the second priority, and the like. In this case, dummy S-NSSAI (for example, S-NSSAI of all “1”) may be included in the Configured NSSAI. For example, the first entry is S-NSSAI (the highest priority) of the network slice #1, the second entry is dummy S-NSSAI (the second highest priority), the third entry is S-NSSAI of network slice #2, and the like. The same applies to Allowed NSSAI or Requested NSSAI. Further, although the first entry has the highest priority and the last entry has the lowest priority in the above-described example, the order of the priorities may be reversed, that is, the first entry may have the lowest priority and the last entry may have the highest priority.

In step S32, when the slice priority transmitted by the gNB 200 or the AMF 300 (for example, the second slice priority) is different from the slice priority desired by the UE 100 (for example, the first slice priority), the gNB 200 transmits the slice priority information including the new slice priority when the available capacity of the radio resource is greater than or equal to the threshold value. The new slice priority is the slice priority desired by the UE 100. The new slice priority may mean a slice priority permitted to the UE 100. When network slices are included in the slice priority information in the form of a list, the order of entries in the list may represent that of slice priorities, same as and/or similarly to step S30.

First, for a specific UE 100, the gNB 200 may transmit slice priority information including, for example, a new priority using an RRC release (RRCRelease) message. That is, the gNB 200 notifies the specific UE 100 of the new priority by transmitting an RRC release (RRCRelease) message including the slice priority information. Furthermore, the AMF 300 may notify the specific UE 100 of the new priority by transmitting a NAS message including the slice priority information to the NAS of the specific UE 100 (step S34).

Second, the gNB 200 may notify multiple UEs 100 of a new priority by transmitting (or broadcasting) an SIB including the slice priority information.

Further, instead of transmitting the slice priority information including the new slice priority, the gNB 200 or the AMF 300 may transmit a message indicating that the slice priority desired by the UE 100 may be prioritized over the slice priority transmitted by the gNB 200 or the AMF 300. The gNB 200 may transmit the message using an RRC message. Alternatively, the AMF 300 may transmit the message using a NAS message.

In step S35, in response to reception of the slice priority information including the new slice priority, the UE 100 performs slice-specific cell reselection using the new slice priority. That is, in response to reception of the slice priority desired by the UE 100 itself, the UE 100 performs slice-specific cell reselection using the slice priority. Since the slice priority is the slice priority desired by the UE 100 itself, a cell supporting the network slice desired by the UE 100 can be reselected by performing slice-specific cell reselection.

### Other Embodiments

A program causing a computer to execute each of the processing performed by the UE 100 or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM.

Circuits for executing processing performed by the UE 100 or the gNB 200 may be integrated, and at least a part of the UE 100 or the gNB 200 may be implemented as a semiconductor integrated circuit (chipset, system on a chip (SoC)).

The phrases “based on” and “depending on” used in the present disclosure do not mean “based only on” and “only depending on”, unless specifically stated otherwise. The phrase “based on” means both “based only on” and “based at least in part on”. The phrase “depending on” means both “only depending on” and “at least partially depending on”. The terms “include”, “comprise” and variations thereof do not mean “include only items stated” but instead mean “may include only items stated” or “may include not only the items stated but also other items”. The term “or” used in the present disclosure is not intended to be “exclusive or”. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Embodiments have been described above in detail with reference to the drawings, but specific configurations are not limited to those described above, and various design variations can be made without departing from the gist of the present disclosure. All or some of the embodiments, operations, processes, and steps may be combined without being inconsistent.

### Supplementary Note

In one embodiment, (1) a slice-specific cell reselection method for a mobile communication system includes: a step of receiving, at a user equipment, a slice priority indicating a priority per network slice from a base station or an access management apparatus; a step of transmitting, at the base station, a slice priority disregard permission message indicating that disregarding the slice priority is permitted when an available capacity of a radio resource is greater than or equal to a threshold value; and a step of performing, at the user equipment, slice-specific cell reselection using a network slice desired by the user equipment without using the slice priority in response to reception of the slice priority disregard permission message.

(2) The slice-specific cell reselection method according to (1) may further include a step of transmitting, at the base station, a slice priority disregard cancellation message indicating cancellation of permission to disregard the slice priority when the available capacity of the radio resource is less than the threshold value after the slice priority disregard permission message has been transmitted; and a step of performing, at the user equipment, slice-specific cell reselection using the slice priority in response to reception of the slice priority disregard cancellation message.

(3) In the slice-specific cell reselection method according to (1) or (2), the step of performing may further include a step of performing, at the user equipment, slice-specific cell reselection using the network slice desired by the user equipment when the slice priority has not been received from the base station or the access management apparatus.

In addition, in one embodiment, (4) a slice-specific cell reselection method for a mobile communication system includes: a step of transmitting, at a user equipment, a first slice priority to a base station or an access management apparatus, the first slice priority indicating a priority per network slice and being desired by the user equipment; a step of transmitting, at the base station or the access management apparatus, the first slice priority if an available capacity of a radio resource is greater than or equal to a threshold value when a second slice priority transmitted by the base station or the access management apparatus is different from the first slice priority; and a step of performing, at the user equipment, slice-specific cell reselection using the first slice priority in response to reception of the first slice priority.

(5) In the slice-specific cell reselection method according to (4), the step of transmitting the first slice priority may further include a step of transmitting, at the base station or the access management apparatus, a message indicating that the first slice priority may be prioritized over the second slice priority, instead of transmitting the first slice priority.

### REFERENCE SIGNS

1: Mobile communication system
20: CN
100: UE
110: Receiver
120: Transmitter
130: Controller
200: gNB
210: Transmitter
220: Receiver
230: Controller
300: AMF

1. A slice-specific cell reselection method for a mobile communication system, the slice-specific cell reselection method comprising the steps of:
receiving, at a user equipment, a slice priority indicating a priority per network slice from a base station or an access management apparatus;
transmitting, at the base station, a slice priority disregard permission message indicating that disregarding the slice priority is permitted when an available capacity of a radio resource is greater than or equal to a threshold value; and
performing, at the user equipment, slice-specific cell reselection using a network slice desired by the user equipment without using the slice priority in response to reception of the slice priority disregard permission message.

2. The slice-specific cell reselection method according to claim 1, further comprising the steps of:
transmitting, at the base station, a slice priority disregard cancellation message indicating cancellation of permission to disregard the slice priority when the available capacity of the radio resource is less than the threshold value after the slice priority disregard permission message has been transmitted; and
performing, at the user equipment, slice-specific cell reselection using the slice priority in response to reception of the slice priority disregard cancellation message.

3. The slice-specific cell reselection method according to claim 1, wherein the performing comprises performing, at the user equipment, slice-specific cell reselection using the network slice desired by the user equipment when the slice priority has not been received from the base station or the access management apparatus.

4. A slice-specific cell reselection method for a mobile communication system comprising the steps of:
transmitting, at a user equipment, a first slice priority to a base station or an access management apparatus, the first slice priority indicating a priority per network slice and being desired by the user equipment;
transmitting, at the base station or the access management apparatus, the first slice priority if an available capacity of a radio resource is greater than or equal to a threshold value when a second slice priority transmitted by the base station or the access management apparatus is different from the first slice priority; and
performing, at the user equipment, slice-specific cell reselection using the first slice priority in response to reception of the first slice priority.

5. The slice-specific cell reselection method according to claim 4, wherein the transmitting of the first slice priority comprises transmitting, at the base station or the access management apparatus, a message indicating that the first slice priority may be prioritized over the second slice priority, instead of transmitting the first slice priority.
